(19) United States
(12) Patent Application Publication
(10) Pub. No.: US 2011/0174119 A1
(43) Pub. Date: Jul. 21, 2011

(54) Low-Profile Tool Apparatus

(75) Inventors: Barbara Norac Weinberg, San Diego, CA (US); Brian Seth Weinberg, San Diego, CA (US)

(73) Assignee: ENCLAVE TECHNOLOGIES, San Diego, CA (US)

(21) Appl. No.: 13/077,161

(22) Filed: Mar. 31, 2011

(51) Int. Cl. B25B 23/16

(52) U.S. Cl. 81/177.1

(57) ABSTRACT

The present invention generally relates to an apparatuses for the use in hard to reach areas that would otherwise be inaccessible. Specifically, this invention relates to a low-profile tool apparatus for accommodating work in areas with a limited amount of space, the low-profile tool comprised of an accessory attachment head, a spring element, one or more spring element height adjustment slots, a handle and a handle extension.

### FIELD OF THE INVENTION

The present invention generally relates to an apparatuses for the use in hard to reach areas that would otherwise be inaccessible. Specifically, this invention relates to a low-profile tool apparatus for accommodating work in areas with a limited amount of space, the low-profile tool comprised of an accessory attachment head, a spring element, one or more spring element height adjustment slots or a height adjustment mechanism, a handle and a handle extension.

### BACKGROUND OF THE INVENTION

Performing work in narrow spaces, such as behind toilets, radiators, pipes or cabinets, has been a constant problem for craftsman in numerous fields. For instance, painters who need to paint behind toilets or radiators have no way of conveniently getting their current tools into such narrow spaces.

Currently no products or tools exist that can accommodate working in spaces whose spacing can be as close as ½″. For painting, mini rollers, standard rollers and brushes are currently used but cannot reach far beyond the edges of the work space without risk of getting paint where it is not intended. For sanding and scraping, no current devices exist that can provide sufficient normal force to said processes. To create the necessary normal force, current tools require a torque to be applied on the handle. To transfer this torque from the handle to the accessory head or roller the tool would have to be very rigid and must provide the necessary spacing for ones hand.

In some cases, the current way of handling narrow working spaces, as discussed above, is to remove the obstruction (e.g., toilet, radiator, cabinet) to allow access to one or more tools that require additional spacing. This can be a time consuming process and may result in damage to the removed obstruction or the area where the obstruction was originally attached.

Therefore, there is a need in the art for a low-profile tool apparatus that can allow craftsman or other individuals to perform work in narrow spaces. These and other features and advantages of the present invention will be explained and will become obvious to one skilled in the art through the summary of the invention that follows.

### SUMMARY OF THE INVENTION

The present invention provides a low-profile tool apparatus for accommodating work in areas that would otherwise be inaccessible. According to an embodiment of the present invention, the low-profile tool apparatus is comprised of an accessory attachment head, a spring element, one or more spring element height adjustment slots height adjustment mechanism, a handle and a handle extension.

According to an embodiment of the present invention, an accessory attachment head of the low-profile tool apparatus is designed to allow for the attachment of one or more tool attachments to be connected to the low-profile tool apparatus. Tool attachments include, but are not limited to, sanding tool attachments, scraping tool attachments and painting tool attachments.

According to an embodiment of the present invention, a spring element of the low-profile tool apparatus is designed to allow for normal force to be applied to a tool attachment against a work surface by applying a counterforce against a support surface. For instance, the spring element may allow for normal force to be applied to a wall to be painted by applying a counterforce against the back wall of a toilet.

According to an embodiment of the present invention, one or more spring element height adjustment slots or height adjustment mechanism that may use a screw or a shaft with a locking mechanism of the low-profile tool apparatus are designed to allow adjustment of the height of the spring element. In this manner, the spring element may be adjusted to an appropriate height such that normal force may be applied to a tool attachment against a work surface in locations of varying widths.

According to an embodiment of the present invention, a handle of the low-profile tool apparatus is designed to allow for a user of the device to maintain a secure grip on the apparatus during use.

According to an embodiment of the present invention, a handle extension of the low-profile tool apparatus is designed to allow a user the ability to reach into narrow spaces.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 is a top perspective view of a low-profile tool apparatus in accordance with an embodiment of the present invention;

FIG. 2 is a bottom perspective view of a low-profile tool apparatus in accordance with an embodiment of the present invention;

FIG. 3 is another top perspective view of a low-profile tool apparatus in accordance with an embodiment of the present invention;

FIG. 4A is a top view of a low-profile tool apparatus in accordance with an embodiment of the present invention;

FIG. 4B is a bottom view of a low-profile tool apparatus in accordance with an embodiment of the present invention;

FIG. 4C is a side view of a low-profile tool apparatus in accordance with an embodiment of the present invention;

FIG. 5A is a perspective view of a low-profile tool apparatus, with a focus on a spring element and spring element height adjustment slots, in accordance with an embodiment of the present invention;

FIG. 5B is a perspective view of a low-profile tool apparatus, with a focus on a spring element and spring element height adjustment slots, in accordance with an embodiment of the present invention;

FIG. 6A is a perspective view of a plurality of spring element height adjustment slots of a low-profile tool apparatus in accordance with an embodiment of the present invention;

FIG. 6B is a perspective view of a low-profile tool apparatus, with a focus on a spring element and spring element height adjustment slots, in accordance with an embodiment of the present invention;

FIG. 7A is a side view of a low-profile tool apparatus, with a focus on a spring element and spring element height adjustment slots, in accordance with an embodiment of the present invention;

FIG. 7B is a side view of a low-profile tool apparatus, with a focus on a spring element and spring element height adjustment slots, in accordance with an embodiment of the present invention;

FIG. 7C is a side view of a low-profile tool apparatus, with a focus on a spring element and spring element height adjustment slots, in accordance with an embodiment of the present invention;

FIG. 7D is a side view of a low-profile tool apparatus, with a focus on a spring element and spring element height adjustment slots, in accordance with an embodiment of the present invention;

FIG. 7E is a side view of a low-profile tool apparatus, with a focus on a spring element and spring element height adjustment slots, in accordance with an embodiment of the present invention;

FIG. 7F is a side view of a low-profile tool apparatus, with a focus on a spring element and spring element height adjustment slots, in accordance with an embodiment of the present invention;

FIG. 8A is a side view of a low-profile tool apparatus, with a focus on a spring element and spring element height adjustment slots, in accordance with an embodiment of the present invention;

FIG. 8B is a side view of a low-profile tool apparatus, with a focus on a spring element and spring element height adjustment slots, in accordance with an embodiment of the present invention;

FIG. 8C is a side view of a low-profile tool apparatus, with a focus on a spring element and spring element height adjustment slots, in accordance with an embodiment of the present invention;

FIG. 8D is a side view of a low-profile tool apparatus, with a focus on a spring element and spring element height adjustment slots, in accordance with an embodiment of the present invention;

FIG. 9A is a perspective view of a low-profile tool apparatus, with a focus on a spring element and an alternate spring element height adjustment method, in accordance with an embodiment of the present invention;

FIG. 9B is a lower perspective view of a low-profile tool apparatus, with a focus on a spring element and an alternate spring element height adjustment method, in accordance with an embodiment of the present invention;

FIG. 9C is a sectional view of a low-profile tool apparatus, showing an alternate embodiment of a spring element height adjustment method, in accordance with an embodiment of the present invention;

FIG. 9D is a sectional perspective view of a low-profile tool apparatus, with a focus on a shaft connected to an alternate embodiment of a spring height adjustment method, in accordance with an embodiment of the present invention;

FIG. 9E is a view of a spring element, in accordance with an embodiment of the present invention;

FIG. 10A is a perspective view of a low-profile tool apparatus, with an alternate spring element height adjustment method, in accordance with an embodiment of the present invention;

FIG. 10B is a close-up perspective view of a low-profile tool apparatus, with an alternate spring element height adjustment method, in accordance with an embodiment of the present invention;

FIG. 10C is a close-up cross-sectional view of a low-profile tool apparatus, with an alternate spring element height adjustment method, in accordance with an embodiment of the present invention;

FIG. 10D is a close-up view of a locking mechanism, in accordance with an embodiment of the present invention; and

FIG. 10E is a close-up view of a locking mechanism, in accordance with an embodiment of the present invention.

### DETAILED SPECIFICATION

The present invention generally relates to an apparatuses for the use in hard to reach areas that would otherwise be inaccessible. Specifically, this invention relates to a low-profile tool apparatus for accommodating work in areas with a limited amount of space, the low-profile tool comprised of an accessory attachment head, a spring element, one or more spring element height adjustment slots slots or height adjustment mechanism that may use a screw or a shaft with a locking mechanism, a handle and a handle extension.

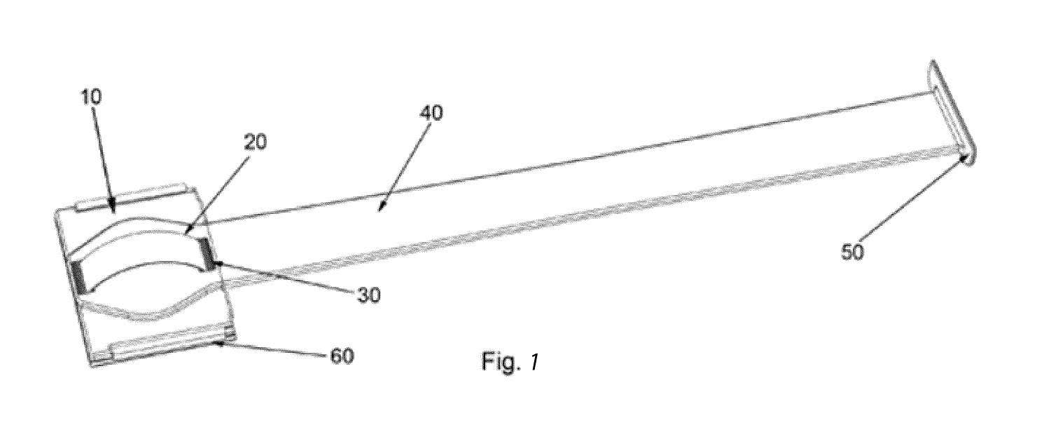

Turning now to FIG. 1, a low-profile tool apparatus, in accordance with an embodiment of the present invention, is shown. The low-profile tool apparatus is comprised of a accessory attachment head 10, a spring element 20, two or more spring element height adjustment slots 30 and a handle extension 40. Optionally, the low-profile tool apparatus may be further comprised of a handle 50, typically received at the end of the handle extension 40.

According to an embodiment of the present invention, the accessory attachment head 10 allows for one or more accessories to be attached to the low-profile tool apparatus. Accessories that could be attached to an accessory attachment head 10 include, but are not limited to, painting pads, sanding pads, edger pads or scraping pads. One of ordinary skill in the art would appreciate that there are numerous types of accessories that could be utilized with embodiments of the present invention, and embodiments of the present invention are contemplated for use with any type of accessory.

Accessories may be attached to the accessory attachment head 10 in numerous manners, including, but not limited to, slide on, clip on, screws or adhesives. According to an embodiment of the present invention, a single accessory attachment head 10 may provide the capability for the attachment of one or more types of accessories. One of ordinary skill in the art would appreciate that there are numerous manners by which accessories could attach to an accessory attachment head 10, and embodiments of the present invention are contemplated for use with any method for attaching accessories to an accessory attachment head 10.

According to an embodiment of the present invention, the spring element 20 and the two or more spring element height adjustment slots 30 work in conjunction to provide the main functionality of the low-profile tool apparatus herein described. Typically, two ends of the spring element 20 are received in two of the two or more spring element height adjustment slots 30. When the spring element 20 is received upon the apparatus in the aforementioned manner, the apparatus may be inserted into a narrow work space a provide a normal force against a work surface. The normal force is created on the work surface by a pressure created between the spring element 20 and a support surface.

For example, a painter may need to paint a wall behind a toilet that is close enough to a wall to prevent the use of normally utilized painter's tools (e.g., mini-rollers, brushes). For such a job, the painter could utilize a low-profile tool apparatus in accordance with an embodiment of the present invention. The painter would place a painting pad on the accessory attachment head 10 of the low-profile tool apparatus and set the spring element 20 in two of the two or more spring element height adjustment slots 30 in such a manner that the height of the top portion of the low-profile tool apparatus, from the front face of the painting pad, to the highest point of the spring element 20, would be slightly greater than the distance between the wall and the toilet. In this manner, when the low-profile tool apparatus is inserted into the space between the wall and the toilet, the spring element 20 is compressed against the toilet, providing a normal force directly against the wall, thereby applying paint from the painting pad to the wall.

According to an embodiment of the present invention, the handle extension 40 attaches to one end of the accessory attachment head 10 and allows for the extension of the low-profile tool apparatus into narrow spaces that would ordinarily prevent a user to perform required work. Certain properties of the handle extension 40 may be variable, based at least in part on specific uses and purposes. Variable properties of a handle extension 40 include, but are not limited to, length, rigidity, width, height, collapsibility, weight and construction material. For example, a low-profile tool apparatus, in accordance with an embodiment of the present invention, may have a handle extension 40 that is intended for use by painters for painting behind toilets. This handle extension 40 may be relatively short (e.g., 2-3 feet) and semi-flexible to allow for curves. I another example, a low-profile tool apparatus, in accordance with an embodiment of the present invention, may have a handle extension 40 that is intended for scraping materials from behind a radiator. This handle extension 40 may be constructed of a material that is rigid and capable of withstanding high temperatures that may be present when in close proximity of a radiator.

According to an embodiment of the present invention, the handle extension 40 may be removably attachable to a accessory attachment head 10 of a low-profile tool apparatus. In this manner, the handle extension 40 may be removed for storage, transport or so that the low-profile tool apparatus may be utilized without the handle extension 40. This may be ideal for situations where the user of a low-profile tool apparatus wishes to rapidly switch from using the low-profile functionality of the apparatus to using the low-profile tool apparatus in areas that do not require the handle extension 40.

Optionally, embodiments of the present invention may be further comprised of a handle 50. Typically, a handle 50 is attached at or near the end of a handle extension 40. The handle may be configured in such a manner as to allow for easy gripping of the low-profile tool apparatus herein described in the hand of a user. The handle 50 may be constructed from numerous materials, depending on a particular purpose or use of the handle. For instance, the handle 50 may be constructed of a soft material, such as foam rubber, to allow for comfort during extended use of the low-profile tool apparatus. One of ordinary skill in the art would appreciate that there are numerous materials from which the handle 50 may be constructed, and embodiments of the present invention are contemplated for use with handles 50 made of any appropriate material.

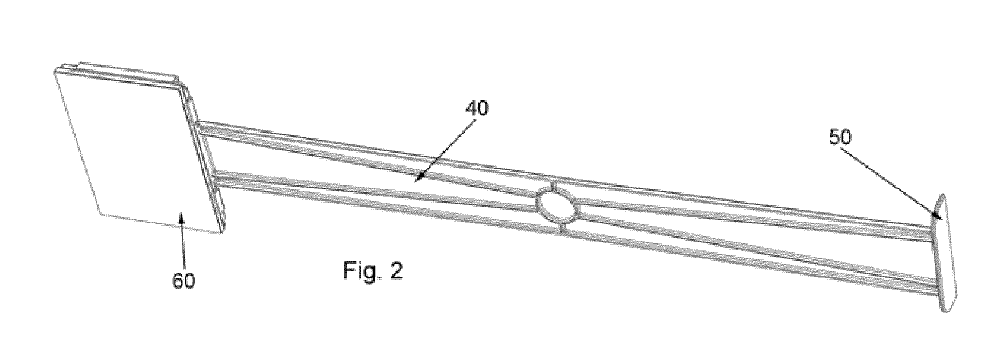

Turning now to FIG. 2, a low-profile tool apparatus, in accordance with an exemplary embodiment of the present invention, is shown. In this exemplary embodiment, a handle 50 is shelled to minimize its mass and ribs are added to stiffen the handle extension 40. Additionally, the accessory head attachment 10 (not shown) has an accessory 60 attached to it.

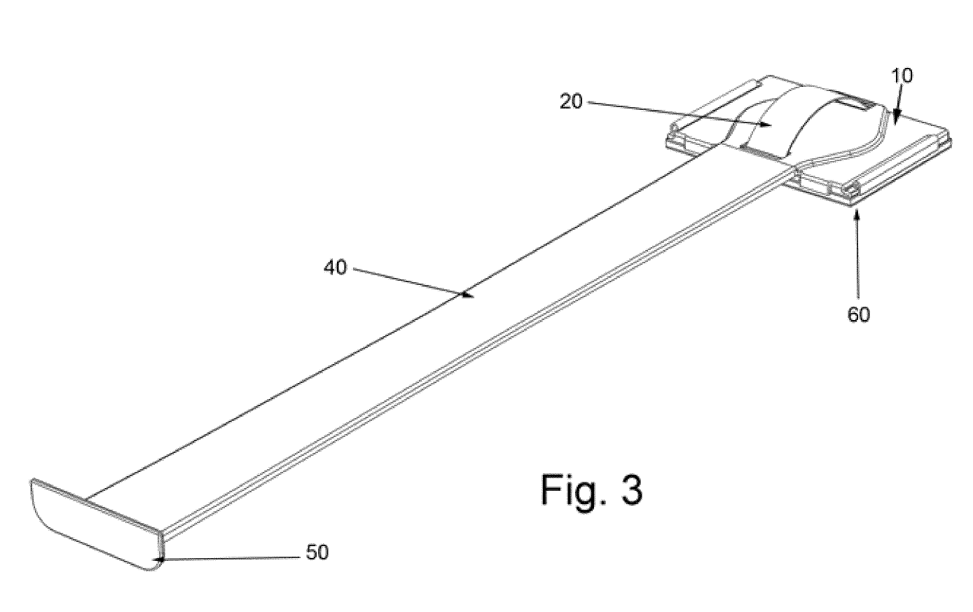

Turning now to FIG. 3, a low-profile tool apparatus, in accordance with an exemplary embodiment of the present invention, is shown. In this exemplary embodiment, the handle 50 is shown as a simple flat feature. Alternatively, handle 50 can include ergonomic features and/or features that help grasping. The handle extension 40 and/or handle 50 may include a protrusion that helps the user maintain proper tool position relative to the surface. The protrusion could be, for instance, a roller or similar features to prevent sliding and marring a freshly worked on surface. The extended length of the handle extension 50 allows for added accessibility to otherwise unreachable surfaces.

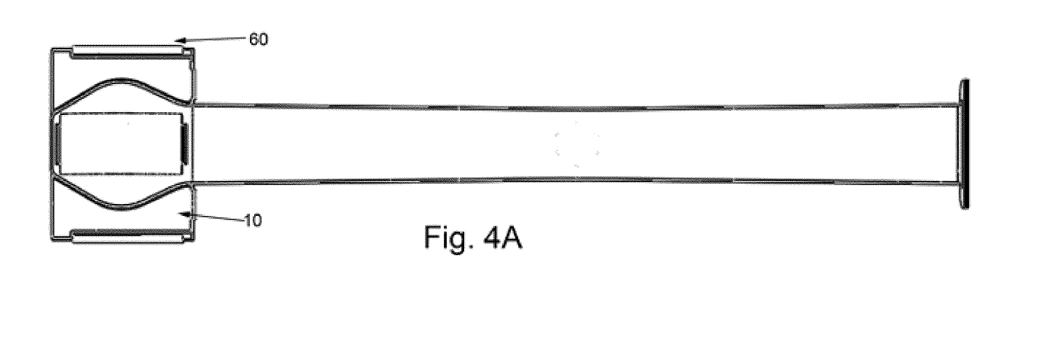

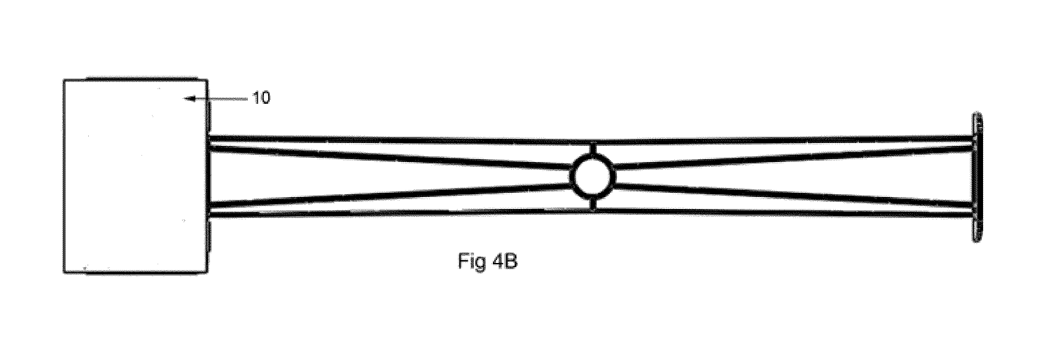

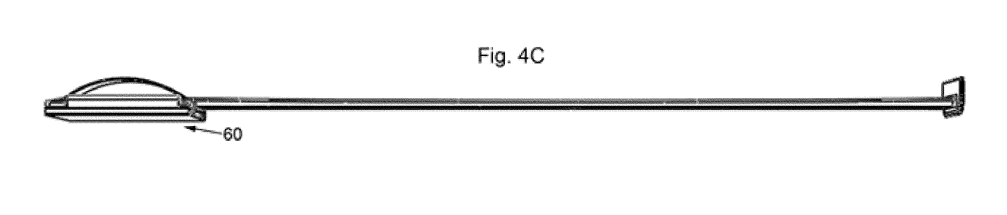

Turning now to FIGS. 4A-4C, a low-profile tool apparatus, in accordance with an exemplary embodiment of the present invention, is shown. FIG. 4A shows a top view of the exemplary embodiment. FIG. 4B shows a bottom view of the exemplary embodiment. FIG. 4C shows a side view of the exemplary embodiment. In these embodiments, an accessory 60 is attached to the accessory attachment head 10.

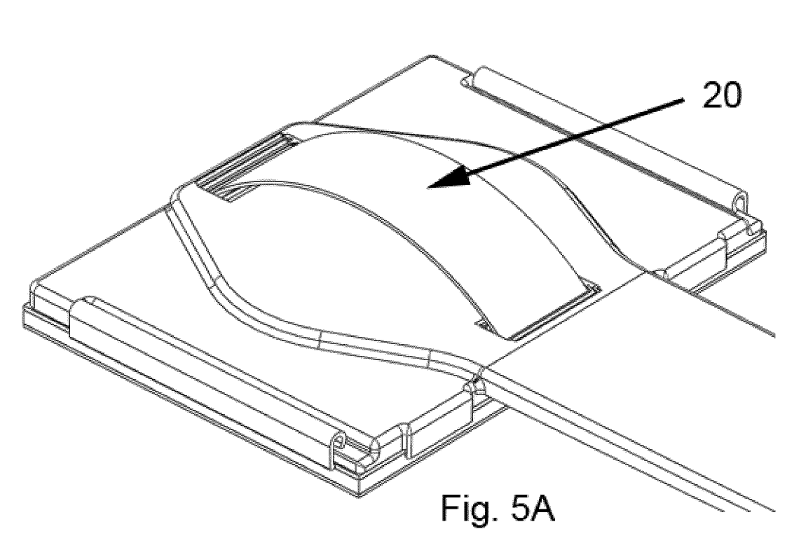

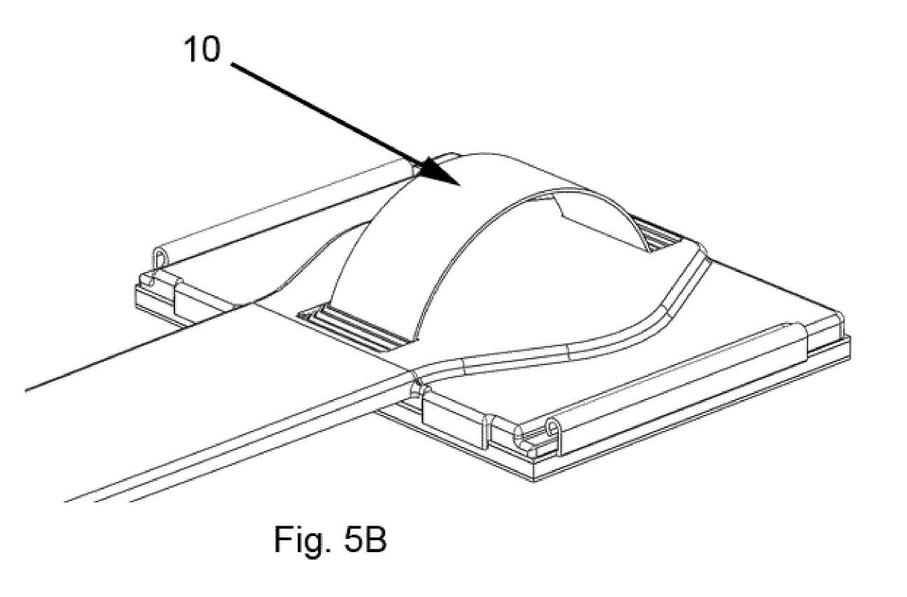

Turning now to FIGS. 5A-5B, a low-profile tool apparatus, in accordance with an exemplary embodiment of the present invention, is shown. FIG. 5A shows the spring element 20 received in two of the two or more spring element height adjustment slots 30. FIG. 5B shows the spring elements 20 received in two alternate spring element height adjustment slots 30. It should be apparent that the height of spring element 20 in FIG. 5A is lower than the height of spring element 20 in FIG. 5B.

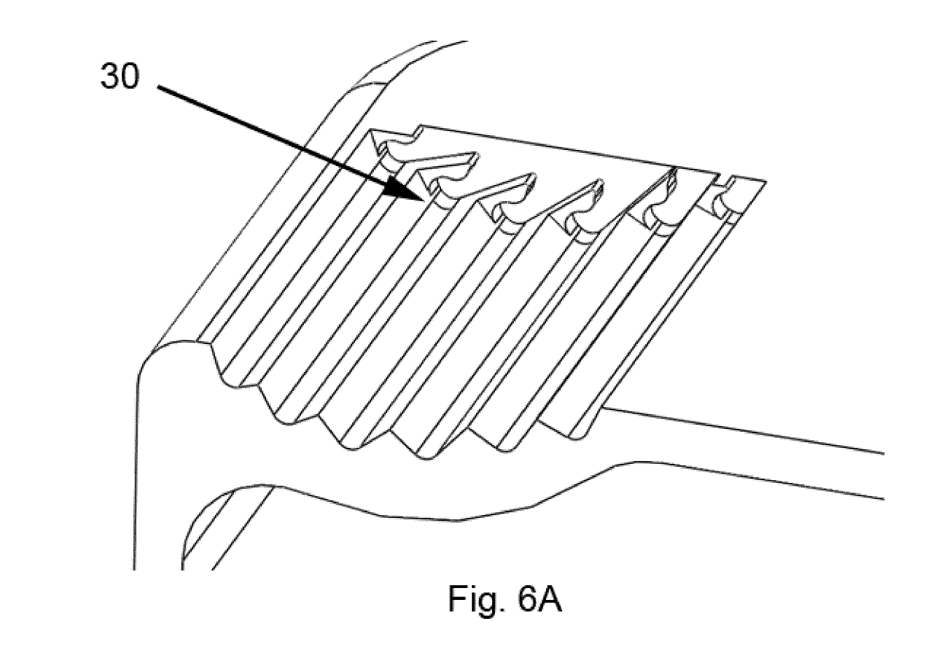

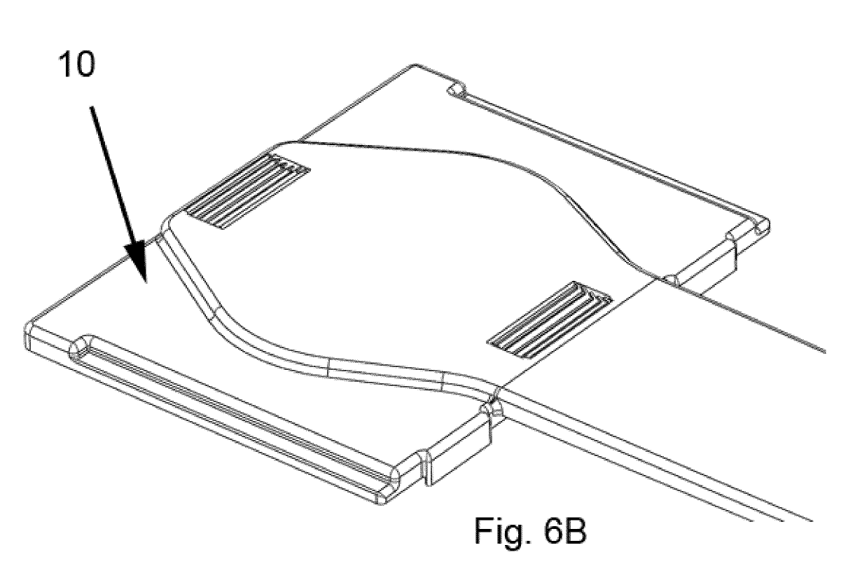

Turning now to FIGS. 6A-6B, a low-profile tool apparatus, in accordance with an exemplary embodiment of the present invention, is shown. FIG. 6A shows a close-up view of the various depths of numerous spring element height adjustment slots 30. By placing an end of the spring element 20 into a spring element height adjustment slot 30, the overall height of the spring element 20 is modified. The overall height of the spring element 20 is modified by the change in depth of the spring height adjustment slot 30 and the distance between the two ends of the spring element 20.

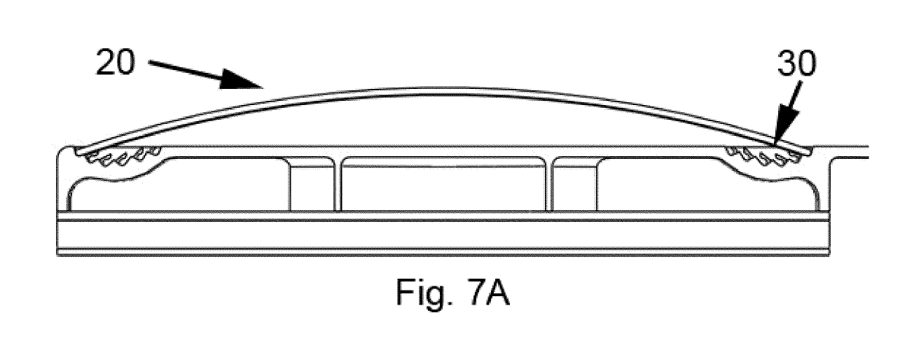

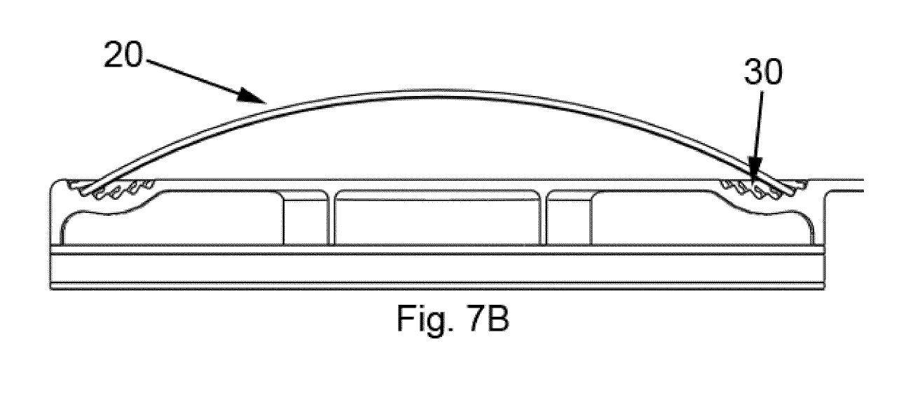

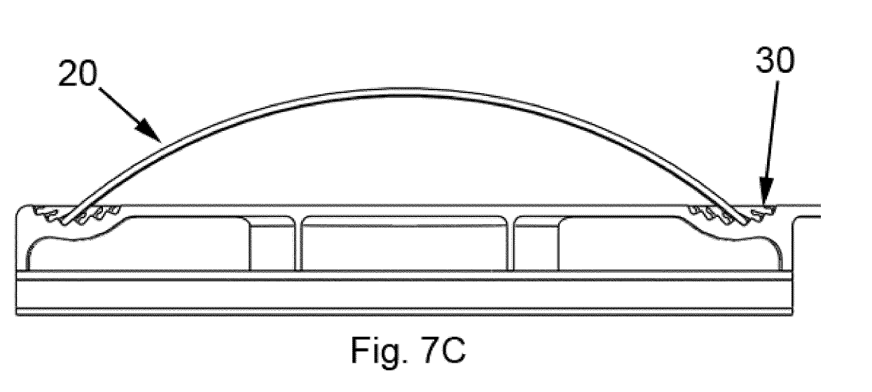

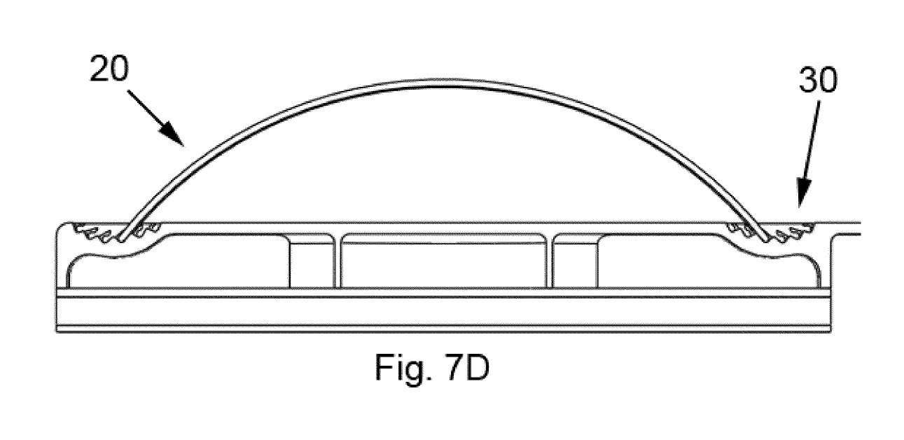

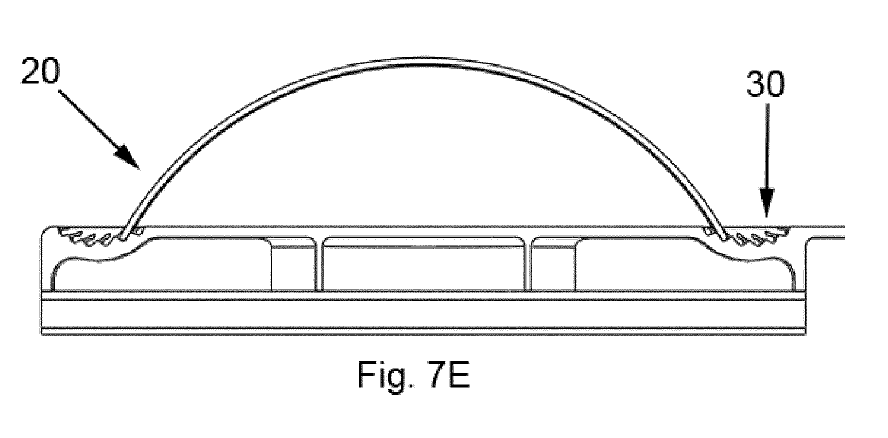

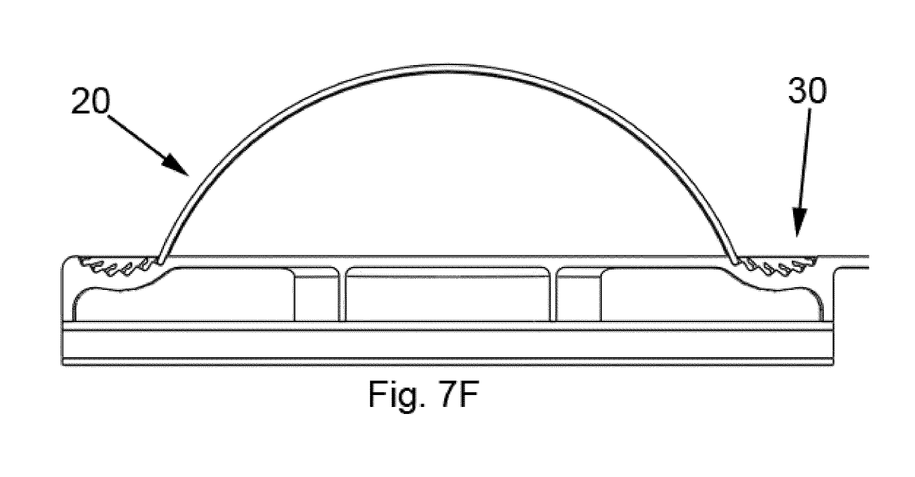

Turning now to FIGS. 7A-7F, a low-profile tool apparatus, in accordance with an exemplary embodiment of the present invention, is shown. FIGS. 7A-7F represent a progression of various overall heights achieved through the movement of one or more ends of a spring element 20 into different spring element height adjustment slots 30.

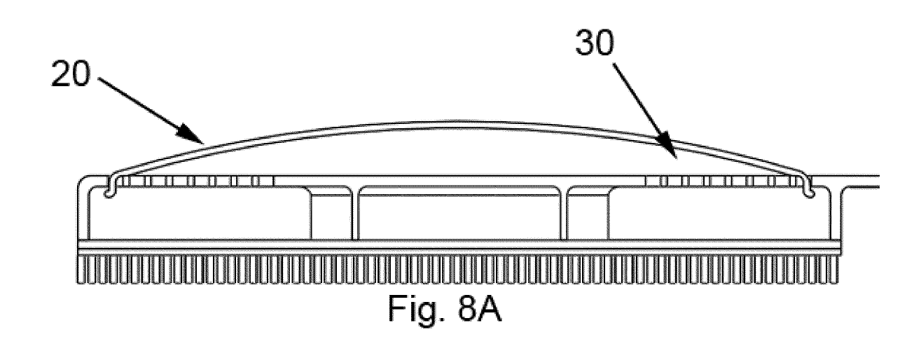

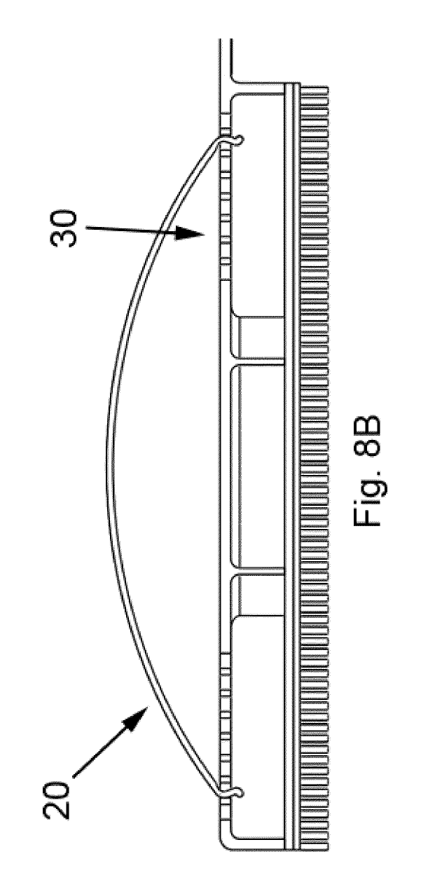

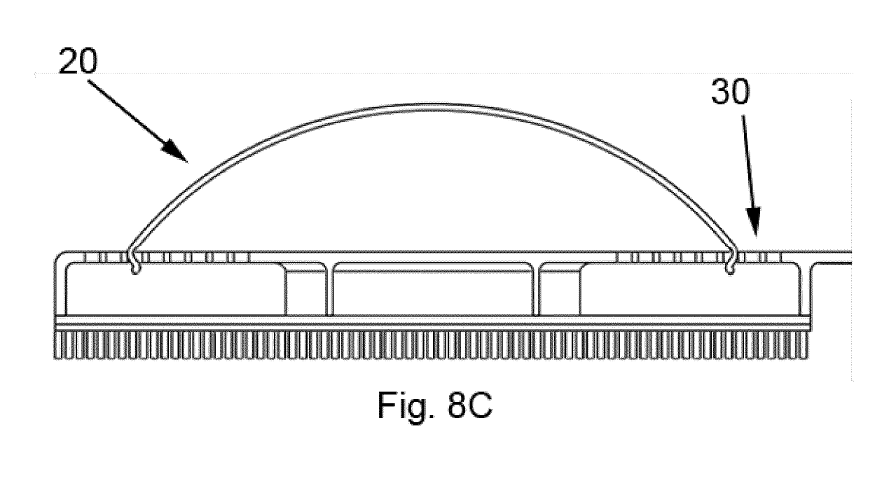

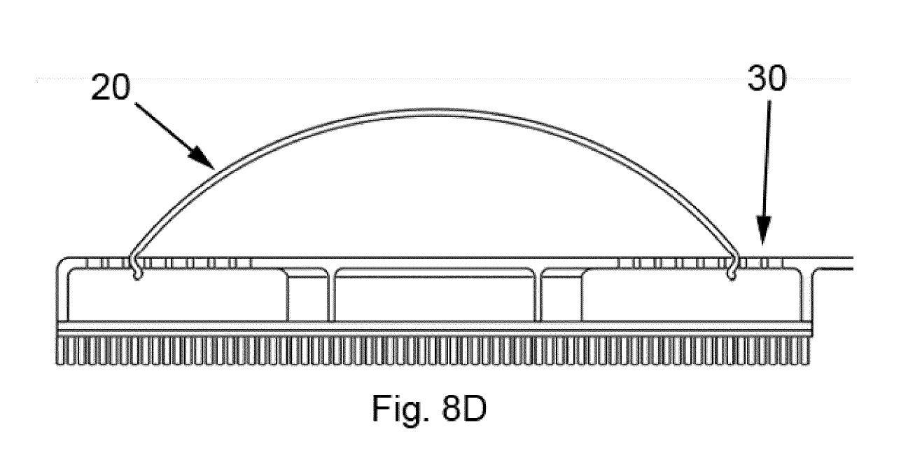

Turning now to FIGS. 8A-8D, a low-profile tool apparatus, in accordance with an exemplary embodiment of the present invention, is shown. FIGS. 8A-8D show an alternate embodiment of spring element height adjustment slots 30. One of ordinary skill in the art would appreciate that numerous types of spring element height adjustment slots 30 could be utilized, and embodiments of the present invention are contemplated for use with any type of spring element height adjustment slots 30. One of ordinary skill in the art would also appreciate that numerous types of other methods to adjust the height of a spring element 20, such as channels and a shaft and/or screw or locking mechanism that serves as a remote method of adjusting the spring height of a spring element 20 at a handle 50 or handle extension 40, and embodiments of the present invention are contemplated for use with any such method of adjusting the height of a spring element 20. Additionally, while the figures contained in this application show the use of two sets of spring element height adjustment slots 30, other embodiments may only use any number of sets of spring element height adjustment slots 30, including, but not limited to one, none, or any other number sets of spring element height adjustment slots 30. In an embodiment with one set of spring element height adjustment slots 30, one end of the spring element 20 may be affixed to the accessory attachment head 10. In an embodiment with no spring element height adjustment slots 30, the spring element could have both ends affixed to the accessory attachment head 10.

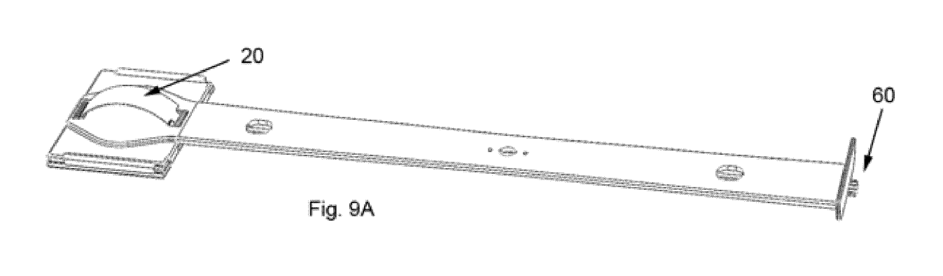

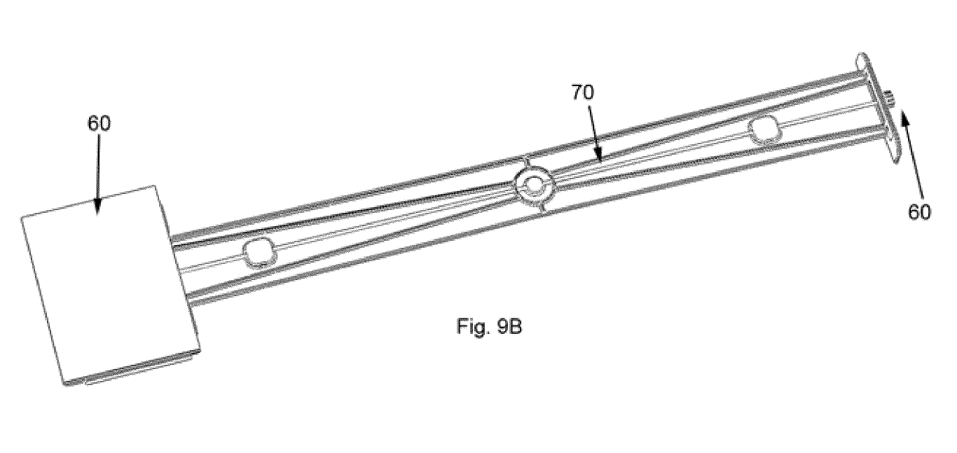

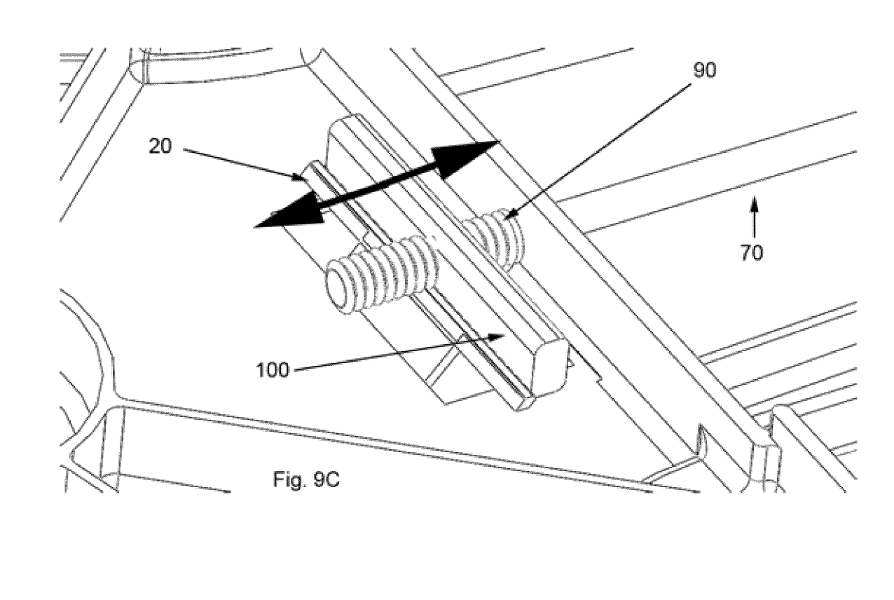

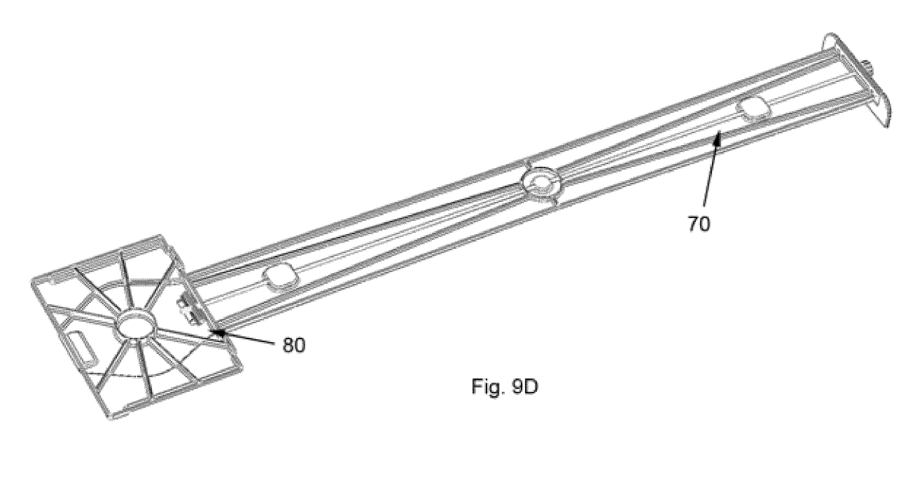

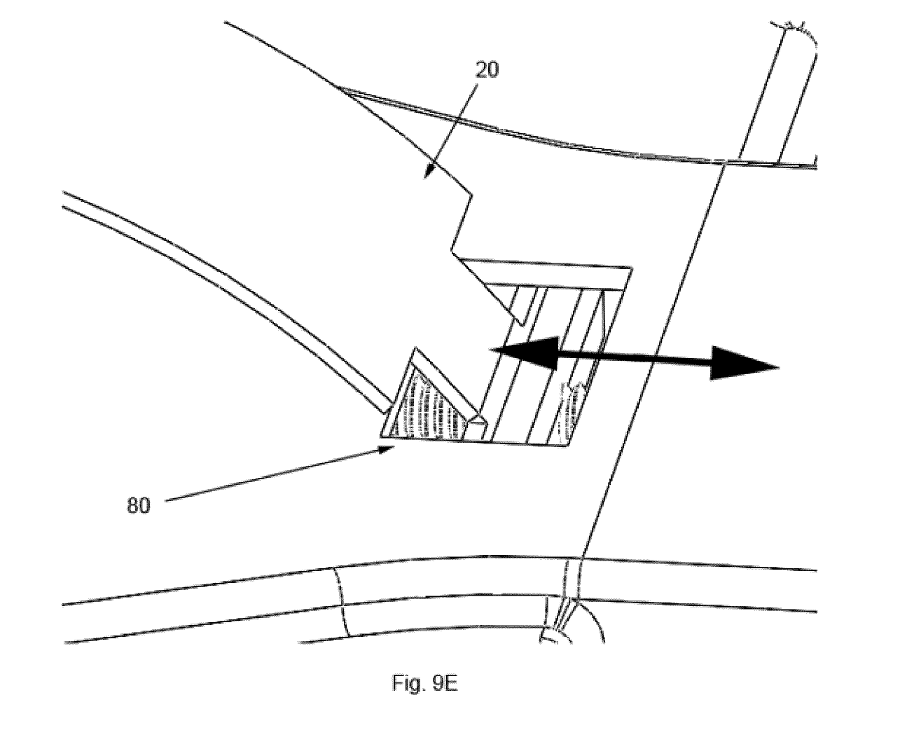

Turning now to FIGS. 9A-9E, a low-profile tool apparatus, in accordance with an exemplary embodiment of the present invention, is shown. In this exemplary embodiment, a spring element height adjustment slot is replaced by a spring element height adjustment method, comprising a screw adjustment mechanism. The screw adjustment mechanism is comprised of a spring element height adjustment knob 60, a shaft 70 and an adjustment slider mechanism 80. One end of a spring element 20 is received in the adjustment slider mechanism 80.

An exemplary embodiment of an adjustment slider mechanism 80 is shown in FIG. 9C. The adjustment slider mechanism 80 is received within an accessory attachment head 10. The adjustment slider mechanism may be comprised of, for instance, a screw mechanism 90 and spring element adjustment slider 100. Screw mechanism 90 is attached to an end of shaft 70 in such a manner that when shaft 70 is rotated via turning of spring element height adjustment knob 60, the spring element adjustment slider 100 is moved along one or more axes. In this embodiment, the spring element adjustment slider 100 may forward and backward along these axes. By moving the spring element adjustment slider 100 forward, the height of spring element 20 is increased and conversely, when spring element adjustment slider 100 is moved backward, the height of spring element 20 is decreased. Advantageously, the height of spring element 20 may be modified while the low-profile tool apparatus is in use.

FIG. 9B is a lower perspective view of a low-profile tool apparatus, with a focus on a spring element and an alternate spring element height adjustment method, in accordance with an embodiment of the present invention. In this embodiment, a shaft 70 runs the entire length of the handle extension 40 and terminates on one end in a height adjustment knob 60 and in an adjustment slider mechanism on the other end (not shown). In other embodiments, the shaft 70 may terminate anywhere along the handle extension 40.

FIG. 9D is a sectional perspective view of a low-profile tool apparatus, with a focus on a shaft connected to an alternate embodiment of a spring height adjustment method, in accordance with an embodiment of the present invention. This embodiment is equivalent to the exemplary embodiment shown in FIG. 9B. Shaft 70 runs the entire length of the handle extension 40 and terminates on one end in a height adjustment knob 60 and in an adjustment slider mechanism on the other end (not shown).

FIG. 9E is a view of a spring element attached to an adjustment slider mechanism, in accordance with an embodiment of the present invention. In this exemplary embodiment, the spring element 20 is received in an adjustment slider mechanism. The adjustment slider mechanism is operable in a forward and backward motion via, for instance, a height adjustment knob 60 located at one end of a handle extension 40. By moving the adjustment slider mechanism forward, the height of spring element 20 is increased and conversely, by moving the adjustment slider mechanism backward, the height of spring element 20 is decreased. Advantageously, the height of the spring element 20 may be modified while the low-profile tool apparatus is in use.

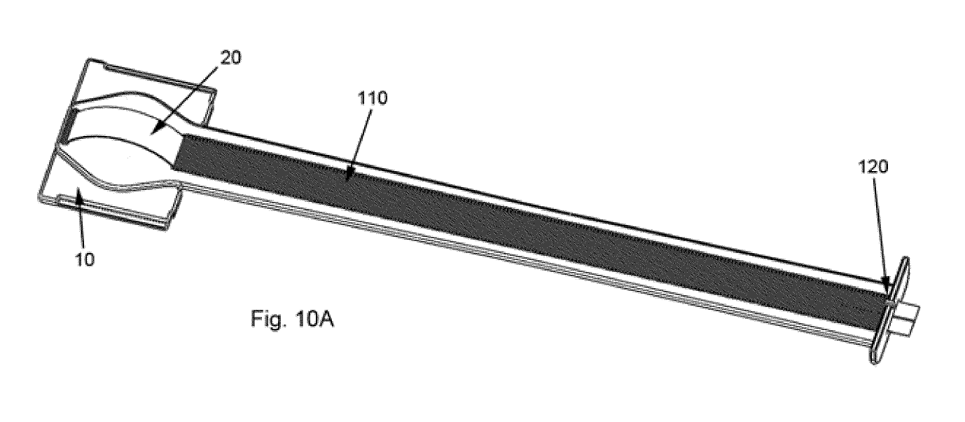

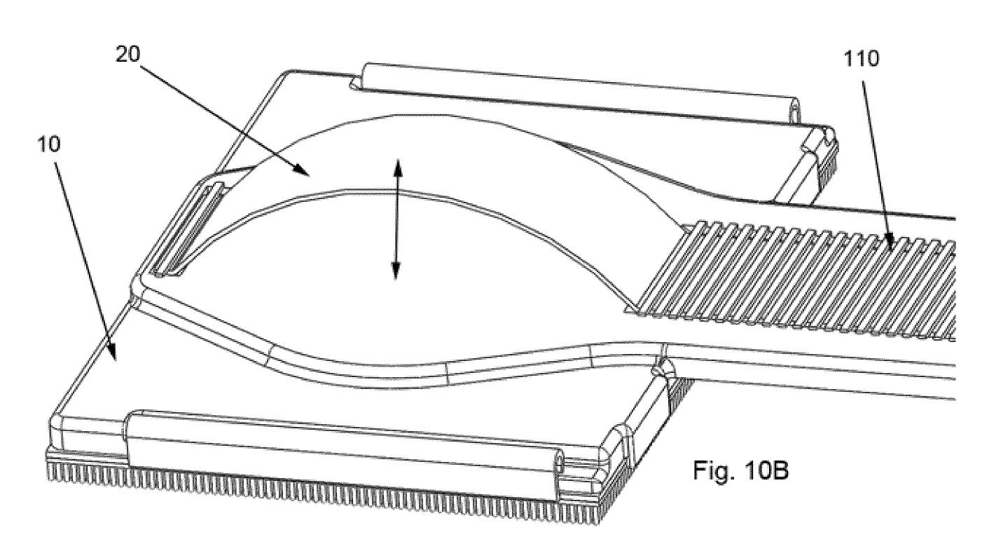

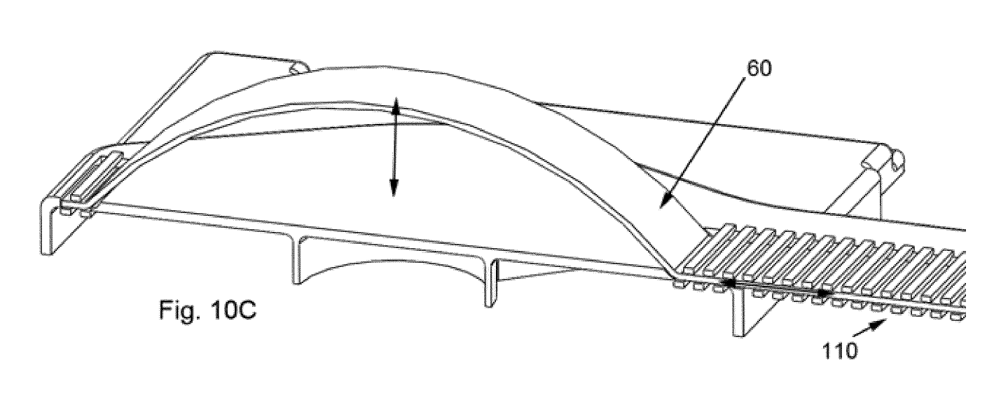

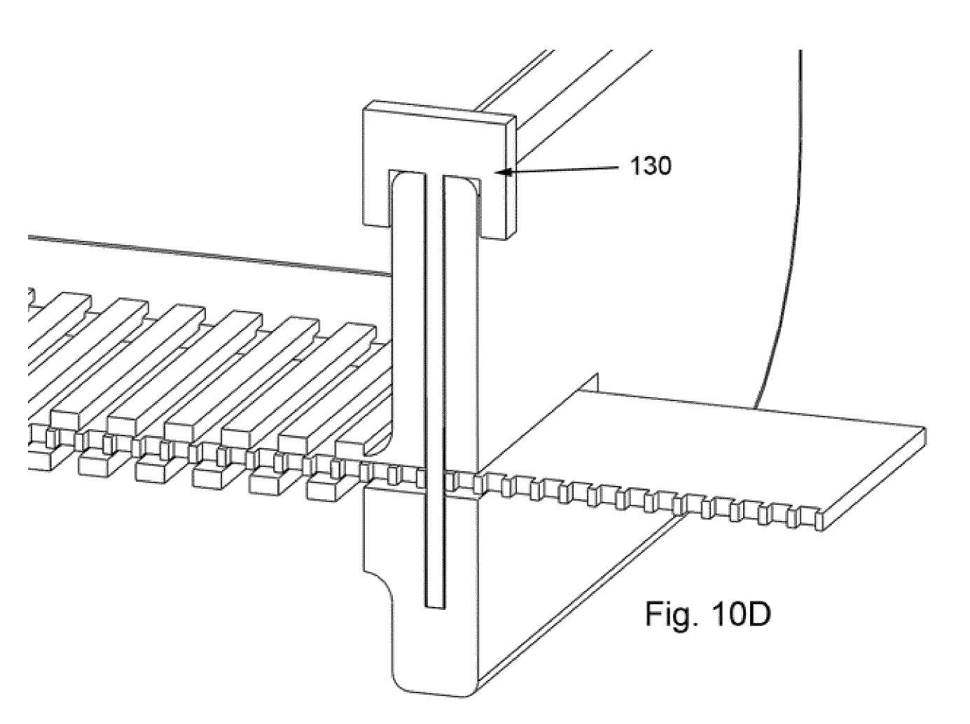

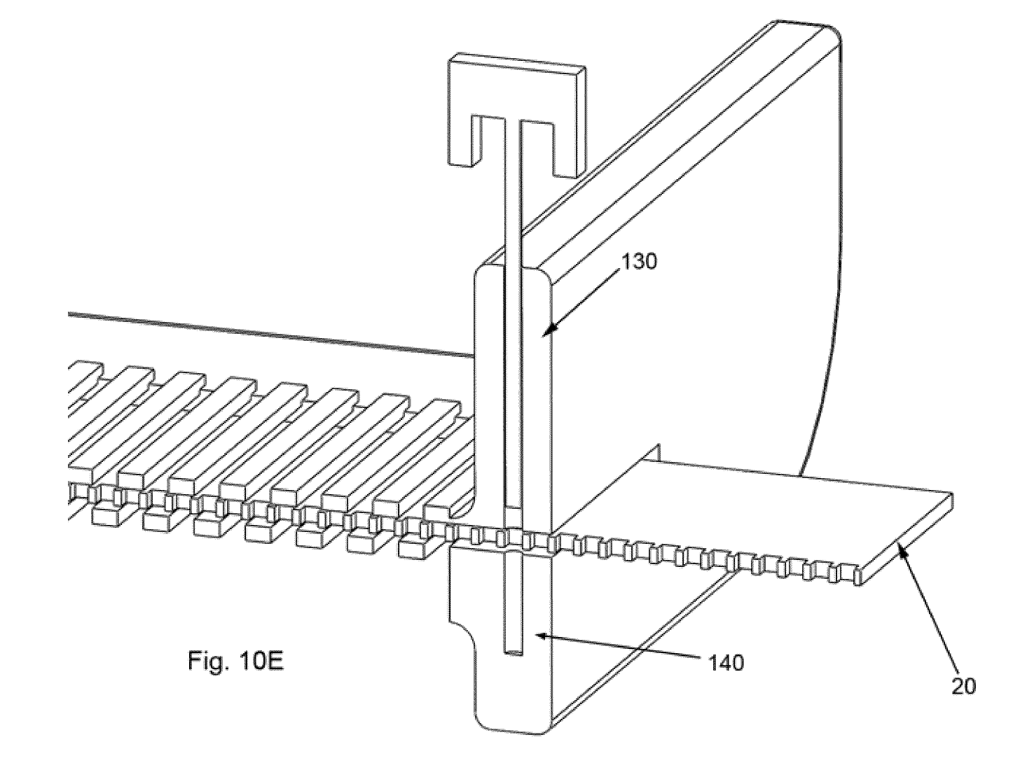

Turning now to FIGS. 10A-10E, a low-profile tool apparatus, in accordance with an exemplary embodiment of the present invention, is shown. In this exemplary embodiment, a spring element height adjustment slot is replaced by a spring element height adjustment method, comprising a plurality of retention slots 110 and a locking mechanism 120. One end of a spring element 20 connected to one end of said plurality of retention slots 110.

An exemplary embodiment of the aforementioned embodiment shown in FIG. 10A. The end of the plurality of retention slots 110 that is connected to said spring element 20 is received within an accessory attachment head 10. The plurality of retention slots 110 runs through the handle extension 40 and exits at the end of the handle extension 40 opposite the accessory attachment head 10. In this configuration, spring height adjustment can be made remotely at the handle 50 via locking mechanism 120. This adjustment can be dynamic where a type of locking mechanism 120 is used that allows for continuous adjustment of the spring height/force during operation. In an alternative embodiment, a locking mechanism 120 with a static adjustment characteristic such as is shown in FIG. 10A that is locked and unlocked to allow for adjustment of the spring height/force of spring element 20. The plurality of retention slots 110 are designed to prevent buckling of the spring element 20 while still allowing for manufacturing via injection molding.

FIGS. 10B-10C shows close-ups of an accessory attachment head 10 in accordance with an exemplary embodiment of the present invention. In this embodiment, the plurality of retention slots 110 is shown attached to spring element 20 in a movable fashion. Ideally, the end of spring element 20 opposite of the end that is attached to the plurality of retention slots 110 is fixed or removably fixed to a spring element height adjustment slot 30 on the accessory attachment head 10.

FIGS. 10D-10E show close-ups of a handle 50 and handle extension 40 with one end of a plurality of retention slots 110 extending from them and a locking mechanism 120 in accordance with an embodiment of the present invention. FIG. 10D shows the locking mechanism 120 in a locked position, with a locking element 130 extending through a lock pathway 140 in such a manner as to prevent the movement of the plurality of retention slots from moving along one or more axes. FIG. 10E shows the locking mechanism 120 in an unlocked position, with a locking element 130 pulled up and away from a lock pathway 140 in such a manner as to allow the movement of the plurality of retention slots 110 from moving along one or more axes. When the locking mechanism is in an unlocked position, the height of the spring element 20 may be adjusted by moving the plurality of retention slots 110 in (for increased spring element 20 height) or out (for decreased spring element 20 height).

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A low-profile tool apparatus, the low-profile tool apparatus comprising:
an accessory attachment head,
wherein said accessory attachment head is comprised of a surface for the attachment of an accessory;
one or more spring element height adjustment slots connected to a side of said accessory attachment head opposite from said surface for the attachment of an accessory; and
a spring element,
wherein one or more ends of said spring element are movably received in one or more of said spring element height adjustment slots.

2. The apparatus of claim 1, further comprising a handle extension, wherein said handle extension extends from one end of said accessory attachment head.

3. The apparatus of claim 2, wherein said handle extension is removably attachable to said accessory attachment head.

4. The apparatus of claim 2, further comprising a handle, wherein said handle is attached to said handle extension.

5. The apparatus of claim 4, wherein said handle is further comprised of a grip.

6. The apparatus of claim 1, wherein said accessory is a painting pad.

7. The apparatus of claim 1, wherein said accessory is a scraping pad.

8. The apparatus of claim 1, wherein said accessory is a sanding pad.

9. A low-profile tool apparatus, the low-profile tool apparatus comprising:
an accessory attachment head,
wherein said accessory attachment head is comprised of a surface for the attachment of an accessory;
an adjustment slider mechanism received inside said accessory attachment head,
wherein said adjustment slider mechanism is movable along one or more axes; and
a spring element,
wherein one or more ends of said spring element are attached to said adjustment slider mechanism.

10. The apparatus of claim 9, further comprising a handle extension, wherein said handle extension extends from one end of said accessory attachment head.

11. The apparatus of claim 10, wherein said handle extension is removably attachable to said accessory attachment head.

12. The apparatus of claim 10, further comprising a handle, wherein said handle is attached to said handle extension.

13. The apparatus of claim 12, wherein said handle is further comprised of a grip.

14. The apparatus of claim 9, wherein said accessory is a painting pad.

15. The apparatus of claim 9, wherein said accessory is a scraping pad.

16. The apparatus of claim 9, wherein said accessory is a sanding pad.

17. The apparatus of claim 9, further comprising a shaft connected to said adjustment slider mechanism, wherein said shaft is configured to alter said adjustment slider mechanism along one or more axes.

18. The apparatus of claim 17, wherein said shaft is received inside a handle extension.

19. The apparatus of claim 17, wherein said shaft is also connected to a spring element height adjustment knob configured to allow operation of said shaft upon said adjustment slider mechanism.
